(19) United States
(12) Patent Application Publication
(10) Pub. No.: US 2016/0219904 A1
(43) Pub. Date: Aug. 4, 2016

(54) MEAT EMULSION PRODUCTS, METHODS OF MAKING SUCH PRODUCTS, AND PET FOODS CONTAINING SUCH PRODUCTS

(71) Applicant: NESTEC SA, VEVEY (CH)

(72) Inventor: Pierre Reynes, Camon (FR)

(21) Appl. No.: 15/002,598

(22) Filed: Jan. 21, 2016

Related U.S. Application Data
(60) Provisional application No. 62/109,223, filed on Jan. 29, 2015.

(51) Int. Cl. A23K 10/20; A23K 50/42; A23K 50/45; A23K 10/30

(52) U.S. Cl. CPC A23K 10/20; A23K 10/30; A23K 50/42; A23K 50/45

(57) ABSTRACT

Meat emulsion products are produced that have a high meat content, for example more than 15 wt %, and also realistic fiber definition, for example linear strands of fiber-like material providing a realistic meat-like appearance. Such meat emulsion products can be made from a viscous dough containing one or more meat meals and humectants, the dough having a low moisture content, such as about 32% or less. Preferably the one or more meat meals are the only meat in the dough. The dough can be emulsified and then set in a high pressure heat exchanger, such as a heat exchanger formed by a first plate and a second plate that form a passage therebetween. The set meat emulsion can be re-sized to form diced chunks of the meat emulsion product. The diced chunks can be cooled and may be blended with a gravy or kibbles or packaged alone.

### CROSS REFERENCE TO RELATED APPLICATIONS

This application claims priority to U.S. Provisional Application No. 62/109,223 filed Jan. 29, 2015, the disclosure of which is incorporated herein by this reference.

### BACKGROUND

The present disclosure relates generally to meat emulsion food products. More specifically, the present disclosure relates to shelf-stable meat emulsion food products with a high meat content and the appearance of meat or fish with a visible fibrous structure.

Meat emulsions are known in the food industry and are widely used in the production of products such as bologna, frankfurters, and other sausage products. Additionally, such meat emulsion products are used to produce pet foods.

Typically, meat emulsion products are prepared by mixing, chopping, and emulsifying a mixture of raw meat materials, such as lean skeletal beef and pork and meat by-products, with ice, salt, spices and curing salts to produce an emulsion that contains fine fat particles coated with protein dissolved from meat ingredients. In the case of a sausage product, the resultant meat emulsion is then stuffed into a suitable casing that serves as a processing mold. The casing is then heated at increasing temperatures for extended periods of time.

The heating of the meat emulsion causes the protein contained therein to coagulate or to set solid. This setting of the protein entraps the fat particles in the protein matrix thereby forming a firm meat emulsion product. The resultant meat emulsion products are a uniform homogeneous mass which contains no discrete particles of meat and retains the shape of the casing when set.

To reduce the cost of certain food products to consumers, in recent years there has been a demand for meat emulsion products that resemble chunks or pieces of natural meat in appearance, texture and physical structure. Such products are used as a partial or complete replacement for more expensive natural meat chunks in food products such as stews, pot pies, casseroles, canned foods, and pet food products. Chunky meat products are highly desirable in human foods and pet foods, both for aesthetic quality and consumer appeal. These chunky products provide a more economical product which attempts to simulate natural meat chunks in shape, appearance, and texture. Retention of shape, appearance, and texture when these products are subjected to commercial canning and retorting procedures is highly desirable.

Meat emulsion products are known that provide a meat-like appearance and texture. However, these products have a low meat content because the structure is achieved using one or more vegetable proteins, such as wheat gluten and/or soya meal.

### SUMMARY

The present disclosure relates to shelf-stable meat emulsion products with a meat content of at least 15 wt % and the appearance of meat or fish with a visible fibrous structure. To make such meat emulsion products, a dry mix containing meat meal and a liquid mix containing humectants can be blended into a viscous dough which has a low moisture content (e.g., about 32% or less). Preferably the dough contains one or more meat meals as the only meat therein. The dough can be emulsified and then set with a high pressure heat exchanger, such as a heat exchanger formed by a first plate and a second plate that form a passage therebetween. The set meat emulsion can be re-sized to form diced chunks of the meat emulsion product. The diced chunks can be cooled and may be blended with a gravy or kibbles or packaged alone.

Accordingly, in a general embodiment, a method of producing a meat emulsion product is provided. The method comprises: forming a dough comprising a humectant, at least 15% of a meat meal, and not greater than about 32% moisture content; subjecting the dough to a temperature above about 100° C. and a pressure of about 40 to about 500 psi to form a meat emulsion; and decreasing the temperature of the meat emulsion in a heat exchanger to set the meat emulsion, and the meat emulsion product comprises the set meat emulsion.

In an embodiment, the humectant comprises glycerol.

In an embodiment, the method comprises comminuting the dough in an emulsion mill that subjects the dough to the temperature above about 100° C. and the pressure of about 40 psi to about 500 psi. The method can comprise conveying the meat emulsion from the emulsion mill to the heat exchanger with a positive displacement pump at a pressure of at least about 80 psi.

In an embodiment, the heat exchanger is a plate heat exchanger comprising plates configured for the meat emulsion to travel therebetween.

In an embodiment, the heat exchanger is configured to subject the heat-set meat emulsion to a pressure of at least 70 psi.

In an embodiment, the meat meal is the only meat in the dough.

In an embodiment, the forming of the dough comprises adding at least one proteinaceous material to the meat meal, and the dough comprises the at least one proteinaceous material in an amount not greater than about 20% of the dough. The at least one proteinaceous material can comprise vital wheat gluten. In an embodiment, a liquid mix comprises water and the humectant, a dry mix comprises the meat meal and the at least one proteinaceous material, and the forming of the dough comprises adding the dry mix to the liquid mix. The method can comprise heating the liquid mix to at least about 70° C. before adding the liquid mix to the dry mix.

In another embodiment, a meat emulsion product is provided. The meat emulsion product comprises a plurality of fibrous structures, at least 15% of a meat meal, and a humectant.

In an embodiment, the meat emulsion product has a water activity not greater than about 0.85.

In an embodiment, the meat emulsion product comprises a proteinaceous material additional to the meat meal, and the proteinaceous material is not greater than about 20% of the meat emulsion product.

In an embodiment, the meat emulsion product has a moisture content not greater than about 25%.

In an embodiment, the meat emulsion product is shelf-stable for at least one year.

In an embodiment, the meat meal is the only meat in the meat emulsion product.

In another embodiment, a pet food is provided. The pet food product comprises: a meat emulsion product comprising a plurality of fibrous structures, at least 15% of a meat meal, and a humectant; and at least one other comestible ingredient.

In an embodiment, the at least one other comestible ingredient comprises dry kibbles.

In an embodiment, the at least one other comestible ingredient comprises a gravy.

An advantage of the present disclosure is to provide improved meat emulsion products.

Another advantage of the present disclosure is to provide improved methods for manufacturing meat emulsion products.

Yet another advantage of the present disclosure is to provide a meat emulsion product that simulates muscle meat while having a high meat content.

Still another advantage of the present disclosure is to provide a meat emulsion product that has a very realistic, meat-like image while having a high meat content.

Another advantage of the present disclosure is to provide a meat emulsion product that has a very realistic meat-like image and a high meat content and retains its integrity and shape when subjected to commercial canning and sterilization procedures such as those required in the production of canned high-moisture food products.

Yet another advantage of the present disclosure is to provide a meat emulsion that can simulate poultry, pork, beef, fish or other meat while having a high meat content.

Still another advantage of the present disclosure is to provide a meat emulsion product that simulates muscle meat which includes a plurality of linear fiber bundles or strands while having a high meat content.

Another advantage of the present disclosure is to provide a meat emulsion product that has a high meat content and is shelf-stable.

Yet another advantage of the present disclosure is to provide improved methods for manufacturing meat emulsion products having the appearance of real meat that are more cost-effective than known methods for making such products.

Still another advantage of the present disclosure is to manufacture a meat emulsion product that simulates muscle meat without using a meat slurry, thereby achieving less complexity and better process control.

Another advantage of the present disclosure is to provide a meat emulsion product that has a high meat content and a strong bite/mouthfeel.

Yet another advantage of the present disclosure is to manufacture a meat emulsion product by using a low moisture content to generate more shear and thereby permit a decreased level of wheat gluten and provide associated cost savings.

Additional features and advantages are described herein, and will be apparent from, the following Detailed Description and the Figures.

### BRIEF DESCRIPTION OF THE FIGURES

FIG. 1 is photograph of an embodiment of a meat emulsion product according to the present disclosure.

FIG. 2 is photograph of another embodiment of a meat emulsion product according to the present disclosure.

FIG. 3 is a schematic diagram of an embodiment of a device for manufacturing meat emulsion products according to the present disclosure.

FIG. 4 is photograph of an embodiment of a set emulsion discharging from a heat exchanger according to the present disclosure.

FIG. 5 is photograph of an embodiment of a blended pet food comprising kibbles and meat emulsion products according to the present disclosure.

FIGS. 6 and 7 are photographs of an embodiment of a blended pet food comprising gravy and meat emulsion products according to the present disclosure.

FIG. 8 is a flowchart of an embodiment of a method for manufacturing meat emulsion products according to the present disclosure.

### DETAILED DESCRIPTION

As used in this disclosure and the appended claims, the singular forms “a,” “an” and “the” include plural referents unless the context clearly dictates otherwise. Thus, for example, reference to “a meat meal” or “the meat meal” includes two or more meat meals. The term “and/or” used in the context of “X and/or Y” should be interpreted as “X,” or “Y,” or “X and Y.” Where used herein, the term “example,” particularly when followed by a listing of terms, is merely exemplary and illustrative, and should not be deemed to be exclusive or comprehensive.

As used herein, “about” is understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All percentages expressed herein are by weight of the total weight of the composition unless expressed otherwise. When reference is made to the pH, values correspond to pH measured at 25° C. with standard equipment.

The terms “food,” “food product” and “food composition” mean a product or composition that is intended for ingestion by an animal, including a human, and provides at least one nutrient to the animal. The term “pet food” means any food composition intended to be consumed by a pet. The term “pet” means any animal which could benefit from or enjoy the compositions provided by the present disclosure. For example, the pet can be an avian, bovine, canine, equine, feline, hircine, lupine, murine, ovine, or porcine animal, but the pet can be any suitable animal. The term “companion animal” means a dog or a cat.

The term “chunks” means a plurality of separate food bodies, and preferably the food bodies are made by slicing the meat emulsion disclosed herein into separate pieces. “Meat analogs” are meat emulsion products that resemble chunks of natural meat in appearance, texture, and physical structure.

As used herein, “dry food” is pet food having a water activity less than 0.65. “Semi-moist food” and “intermediate moisture food” is pet food having a water activity from 0.65 to 0.85. “Wet food” is pet food having a water activity more than 0.85. “Shelf-stable” means stable at ordinary temperatures for at least one year.

“Kibbles” are pieces of dry pet food which can have a pellet shape or any other shape. Non-limiting examples of kibbles include particulates; pellets; pieces of petfood, dehydrated meat, meat analog, vegetables, and combinations thereof; and pet snacks, such as meat or vegetable jerky, rawhide, and biscuits. The present disclosure is not limited to a specific form of the kibbles.

As used herein, the terms “fiber-like,” “meat-like” and “kibble-like” to describe the meat emulsion products mean that the meat emulsion products possess, in part, the same or almost the same physical appearance and characteristics as actual fibers, meats and kibbles, respectively, as understood by the skilled artisan. The meat emulsion products are produced that have realistic fiber definition that provides a very realistic meat-like appearance similar to that of muscle meat.

As used herein, “meat meal” is meat that has been dried and ground to form substantially uniform-sized particles. For example, the Association of American Feed Control Officials (AAFCO) defines “meat meal” as the rendered product from mammal tissues, exclusive of any added blood, hair, hoof, horn, hide trimmings, manure, stomach and rumen contents except in such amounts as may occur unavoidably in good processing practices, and shall not contain extraneous materials not provided for by this definition. Non-limiting examples of meat meals suitable for the compositions disclosed herein include beef meal, poultry meal, pork meal, turkey meal, fish meal and combinations thereof. Beef meal is the rendered product from beef tissues, exclusive of any added blood, hair, hoof, horn, hide trimmings, manure, stomach and rumen contents, except in such amounts as may occur unavoidably in good processing practices. Poultry meal is the dry rendered product from a combination of clean flesh and skin with or without accompanying bone, derived from the parts of whole carcasses of poultry or a combination thereof, exclusive of feathers, heads, feet, and entrails. Pork meal is the dry rendered product from a combination of clean flesh and skin (with or without accompanying bone), derived from the parts of whole carcasses of pigs or combination thereof, exclusive of head, feet or entrails. Turkey meal is the dry rendered product from a combination of clean flesh and skin with or without accompanying bone, derived from the parts of whole carcasses of turkeys, exclusive of feathers, heads, feet, or entrails. Fish meal is the clean, dried, ground tissue of undecomposed whole fish or fish cuttings, either or both, with or without the extraction of part of the oil.

The terms “enhanced palatability” and “enhancing palatability” mean that a palatant prepared according to the present disclosure improves the palatability of a food composition relative to an identically formulated food composition lacking the palatant. “Palatability” refers to a quality of a comestible composition that makes it appealing or pleasing to one or more of an animal's senses, particularly the senses of taste and smell. As used herein, whenever an animal shows a preference, for example, for one of two or more foods, the preferred food is more “palatable” and has greater “palatability.” For companion animals and other non-human animals, the relative palatability of one food compared to one or more other foods can be determined, for example, in side-by-side, free-choice comparisons, e.g., by relative consumption of the foods, or other appropriate measures of preference indicative of palatability.

The compositions disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein.

In an aspect of the present disclosure, shelf-stable meat emulsion products (e.g. semi-moist kibbles or chunks) have a meat meal content of at least 15 wt % and the appearance of meat or fish with a visible fibrous structure. The meat emulsion product can simulate any type of meat product including poultry, beef, pork, fish and combinations thereof. In some embodiments, the meat meal content is at least 30%, at least 35% or at least 45% of the meat emulsion product. These meat emulsion products are preferably semi-moist chunks that contain at most about 20 wt % of wheat gluten while having a fibrous, meat-like imagery that is similar to that of meat emulsion chunks with a higher level (about 25%) of vital wheat gluten.

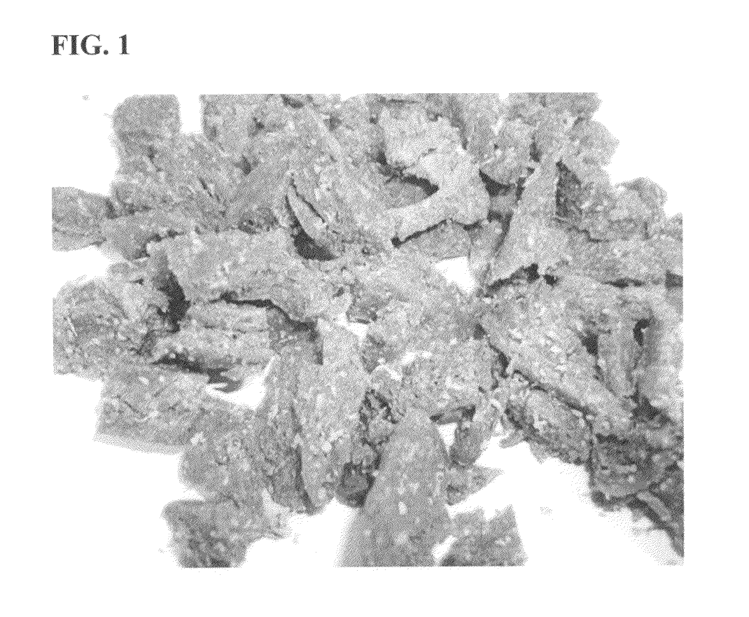

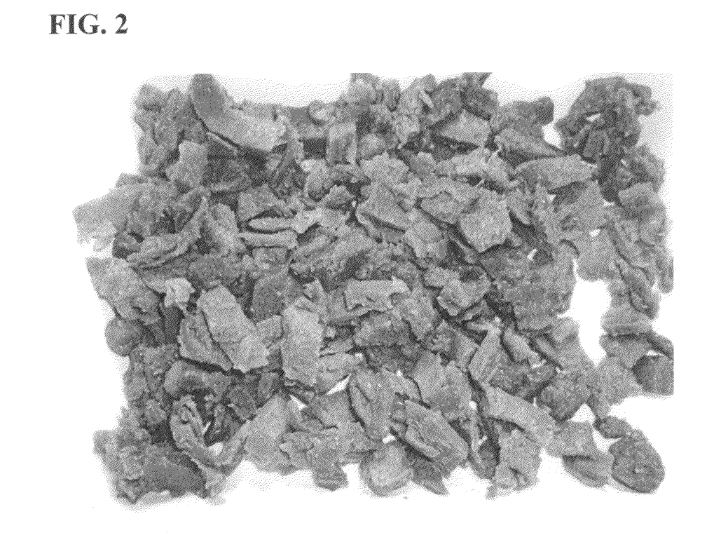

Referring to the figures, FIGS. 1 and 2 depict an embodiment of a meat emulsion product according to the present disclosure. Although the products disclosed herein are meat emulsions at least in part, they possess the same or almost the same characteristics as real meat. As set forth in detail below, pursuant to the present disclosure a meat emulsion product is produced that has improved fiber definition (visible small diameter fibers) that provides a very realistic meat-like image. In this regard, the resultant meat emulsion product has fiber bundles or strands that afford the meat emulsion a very realistic muscle meat appearance. For example, a poultry meat emulsion product according to the present disclosure has the appearance of tender slow cooked chicken or turkey that was hand-pulled from the bone covered in its own broth/juice. Additionally, the meat emulsion product has irregular product shape and dimensions, has a stronger bite/mouth feel, and is not pasty, mushy or brittle.

As set forth in detail below, an embodiment of the meat emulsion product can be produced by emulsifying a dough having a moisture content of at most about 32%, preferably about 30% or less, and comprising one or more meat meals, a humectant, and various ingredients. The meat emulsion can then conveyed through a high speed emulsion mill wherein the emulsion is rapidly heated to thermally gel the emulsion. The heated meat emulsion is then discharged into a high pressure heat exchanger in which the meat emulsion solidifies into a striated meat-like structure.

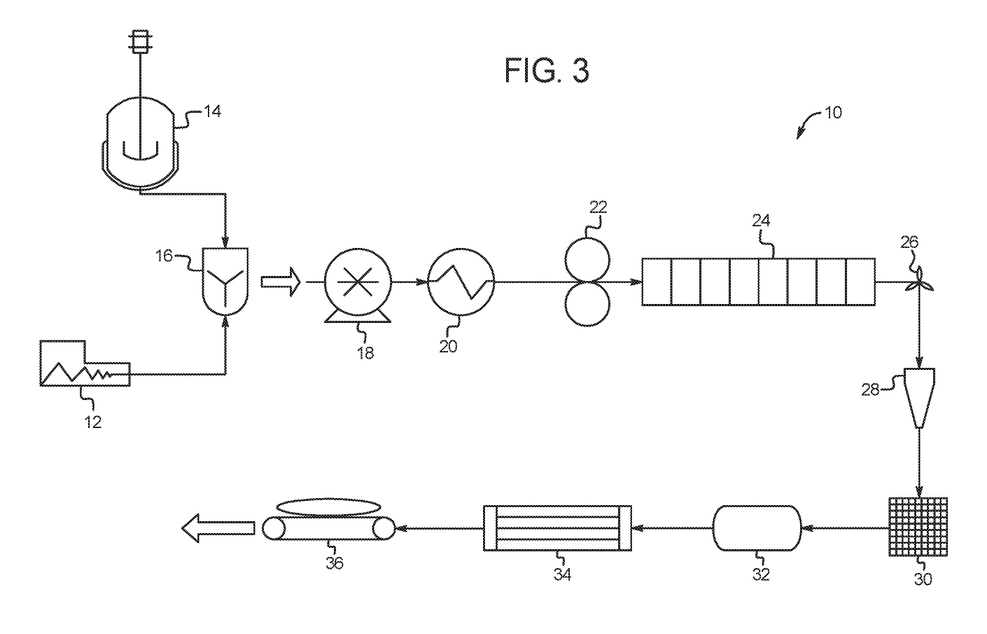

FIG. 3 is a schematic diagram of an embodiment of a system 10 for manufacturing meat emulsion products provided by the present disclosure. The system 10 can comprise a dry mix hopper 12 and a heating tank 14 that respectively meter a dry mix and a liquid mix into a mixer 16. The dry mix can be combined with the liquid mix in the mixer 16 to form a high viscosity dough.

The dry mix contains one or more meat meals, and preferably the one or more meat meals are the only meat in the dry and liquid mixes. In various embodiments, the one or more meat meals are at least 15%, preferably at least 30%, more preferably at least 35% of the dough, and even at least 45% of the dough in some embodiments.

Preferably the dry mix comprises one or more dry proteinaceous materials. Alternatively or additionally, at least a portion of the dry proteinacous materials can be added to the mixer 16 separately from the dry mix. In an embodiment, the dry proteinaceous material is included in the meat emulsion in an amount from about 5% to about 20% of the emulsion, depending on such factors as the intended use of the product, the quality of meat material used in the emulsion, ingredient cost considerations, and the like. Non-limiting examples of suitable dry proteinaceous materials include wheat gluten, soy flour, soy protein concentrate, soy protein isolate, egg albumin, nonfat dry milk, and combinations thereof.

Optionally the dry mix can include other components in addition to the one or more meat meals and the dry proteinaceous materials, such as one or more of a vitamin, a mineral, a preservative, an antioxidant, a colorant, cereal materials from (e.g., wheat, corn, rice, barley, oats, sorghum, millet, rye, or triticale), other grains such as buckwheat, amaranth, quinoa, wild rice, teff, spelt.

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. Non-limiting examples of suitable preservatives include potassium sorbate, sorbic acid, sodium methyl para-hydroxybenzoate, calcium propionate, propionic acid, and combinations thereof.

The antioxidant can provide an aesthetic effect and influence the odor of the meat emulsion product, particularly during extended shelf-life. Non-limiting examples of suitable antioxidants include butylated hydroxyanisole (BHA), butylated hydroxytoluene (BHT), vitamin E (tocopherols), and combinations thereof. Non-limiting examples of suitable colorants include FD&C colors, such as blue no. 1, blue no. 2, green no. 3, red no. 3, red no. 40, yellow no. 5, yellow no. 6, and the like; natural colors, such as roasted malt flour, caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The liquid mix contains one or more humectants which can be any compound that has humectant properties and is compatible with food compositions. In various embodiments, the humectant plasticizers are polyols. In preferred embodiments, the humectant is one or more of glycerol (glycerin), sorbitol, propylene glycol (e.g., monopropylene glycol), butylene glycol, polydextrose, or combinations thereof. The humectant is preferably glycerol and/or propylene glycol and is more preferably glycerol only. In various embodiments, the humectant is from about 4% to about 25% of the dough. In an embodiment, the glycerol and any monopropylene glycol are present in a total amount of about 21% of the dough.

Chicken fat can be used in the liquid mix to reduce stickiness of the dough, if desired. The liquid mix also contains water, preferably in an amount not greater than about 32% of the dough, more preferably an amount not greater than about 30% of the dough. In some embodiments, the amount of the water is not greater than about 20% of the dough, for example an amount that is about 17% of the dough.

Preferably the dough comprises at least about 20% protein by weight and less than about 20% fat by weight.

The resultant meat emulsion product should have a substantially similar profile to that of the dough. Therefore, in some embodiments the weight percentages of the ingredients disclosed above as relative to the dough are the same or substantially the same relative to the resultant meat emulsion product. However, if another comestible product is added to the resultant meat emulsion product, such as gravy, broth or other kibbles, the final profile could change due to the moisture, protein and/or fat content of the other comestible product.

The heating tank 14 can heat the liquid mix before dosing the liquid mix into the mixer 16. In an embodiment, the heating tank 14 heats the liquid mix to a temperature of at least about 70° C.

The dry mix can combined with the liquid mix meat in the mixer 16, where the liquid and dry mixes form a substantially homogenous dough. Non-limiting examples of suitable mixers are batch mixers and continuous mixers. Preferably the substantially homogenous dough is heated in the mixer 16, such as by hot water jacketing, steam injection, and the like to facilitate pumping of the dough formed from the dry and liquid mixes.

Typically the temperature of the ingredients of the dry mix increase from being combined with the heated liquid mix in the mixer 16. This heating is not objectionable as long as the temperature does not increase to the point that protein denaturation begins to occur at an undesirable rate at this stage of the process.

The system 10 can comprise a transfer pump 18 that conveys the dough from the mixer 16 to a high temperature emulsifier 20. The high temperature emulsifier 20 forms a meat emulsion from the dough. Preferably the dough has not been subjected to any emulsification prior to the high temperature emulsifier 20.

The high temperature emulsifier 20 is preferably an emulsion mill configured to comminute the meat emulsion to increase the fineness of the emulsion and also rapidly heat the meat emulsion to a temperature above the boiling point of water (i.e., above about 100° C.), at which temperature the coagulation of protein in the emulsion proceeds so rapidly that the emulsion is set and a firm emulsion product formed within a very short period of time, for example a time period not greater than 20 seconds.

Rapidly heating the viscous meat emulsion to a temperature above the boiling point of water, for example about 120° C. to about 165° C., and preferably between about 145° C. to about 155° C., can coagulate the protein in the meat emulsion to set the emulsion and form a firm emulsion product within about 5 minutes and typically from a few seconds to about 3 minutes after heating. At this stage in the process, the meat emulsion is under a pressure of approximately 40 psi to about 500 psi and preferably 60 psi to 350 psi. The high temperature and increased pressures provide fiber definition to the resultant meat emulsion product. The higher the product temperature and pressure, the better the fiber development (linear alignment with smaller long fibers).

Preferably, the high temperature emulsifier 20 is configured to heat the meat emulsion to such elevated temperatures while comminuting the meat emulsion, for example by mechanical heating and/or steam injection. According to a preferred embodiment, the viscous meat emulsion, which is at a temperature of between about 30° C. to about 40° C., is pumped through the high temperature emulsifier 20, and the high temperature emulsifier 20 subjects the meat emulsion to shearing to increase the fineness of the emulsion and almost simultaneously heat the emulsion to between about 120° C. to about 165° C., preferably 145° C. to about 155° C., through rapid mechanical heating and/or steam injection. Thus, the emulsion preferably is heated to such elevated temperatures in a period of less than about 60 seconds. When the emulsion has been heated to such an elevated temperature in this manner, further significant shearing and cutting of the emulsion should be avoided. Control of the emulsion temperature within the desired range can be effected by adjusting such factors as the feed rate into the high temperature emulsifier 20, the rotational speed of the high temperature emulsifier 20, and the like, and can readily be determined by those skilled in the art

The hot meat emulsion, which is at a temperature above the boiling point of water and generally in the range of between about 120° C. to about 165° C., preferably about 145° C. to about 155° C., can be transferred by a positive displacement pump 22, for example a gear or lobe pump, from the high temperature emulsifier 20 to a high pressure heat exchanger 24. In an embodiment, the positive displacement pump 22 is configured to pump the hot meat emulsion at high pressures of about 80 psi or higher. For example, the hot meat emulsion can generally be pumped at pressures of about 80 psi to about 600 psi, preferably about 100 psi to about 500 psi, and most preferably 140 psi to about 350 psi into the high pressure heat exchanger 24. The hot emulsion can also be pumped at pressures higher than 600 psi using suitable equipment.

At such high pressures, the process operates at around the upper pressure limit of the high temperature emulsifier 20 (e.g. 235 psi). For at least this reason, the positive displacement pump 22 is preferably a gear pump having a pressure limit of 500 to 2500 psi and above that is close-coupled directly after the emulsifier 20. This embodiment allows the high temperature emulsifier 20 to develop the high temperature without the high pressure. The pressure will be developed after the positive displacement pump 22 and preferably reduce the pressures in the high temperature emulsifier 20 to pressures from 60 psi to 100 psi.

The high pressure heat exchanger 24 preferably is configured to control flashing of moisture from the meat emulsion. The meat emulsion is retained in the high pressure heat exchanger 24 at a pressure above the vapor pressure of the emulsion until the protein in the meat emulsion has coagulated sufficiently to set the emulsion and form a firm emulsion product, which retains its shape and structure when discharged from the high pressure heat exchanger 24. At such elevated temperature, protein coagulation proceeds at a very rapid rate. In an embodiment, the high pressure heat exchanger 24 subjects the meat emulsion to a pressure of at least 70 psi.

The period of time required for the hot meat emulsion to set sufficiently to form a firm product will depend on a number of factors, such as the temperature to which the emulsion is heated and the amount and type of protein in the emulsion. Nevertheless, a residence time of between a few seconds to about 3 minutes, and usually between about 1 to about 1.5 minutes, in the high pressure heat exchanger 24 is generally sufficient for the protein to sufficiently coagulate and form a firm emulsion product which will retain its shape, integrity, and physical characteristics. The residence time in the high pressure heat exchanger 24 can be controlled by adjusting the flow rate of the meat emulsion to the high pressure heat exchanger 24 and/or by adjusting the length of the high pressure heat exchanger 24.

Preferably, the high pressure heat exchanger 24 is configured to cool the meat emulsion travelling therethrough. The high pressure heat exchanger 24 can comprise an external jacket or other cooling components circumscribing the passage. A rectangular or similar shaped passage may provide a preferred design so as to afford a structure that can be externally cooled and allow the product contained in the center of the passage to be sufficiently cooled.

In a preferred embodiment, the high pressure heat exchanger 24 is a high pressure plate heat exchanger, for example one of the high pressure plate heat exchangers disclosed in PCT Application Nos. PCT/US2012/044889 and PCT/US2012/044933 and published as WO2013/015944 and WO2013/015946, respectively, fully incorporated herein by reference in their entireties.

For example, a first embodiment of the high pressure heat exchanger 24 can comprise a first plate, a second plate attached to the first plate, and a first spacer and a second spacer arranged between the first plate and the second plate. The first plate, the second plate, the first spacer and the second spacer can define at least one temperature-controlled passage for the meat emulsion to pass through the high pressure heat exchanger 24.

Temperatures within the temperature-controlled passage of the high pressure heat exchanger 24 can be controlled by passing a fluid through at least one channel in a portion of at least one of the first plate or the second plate. For example, the first plate and the second plate can define a plurality of individual temperature-controlled zones. The temperatures of individual temperature-controlled zones can be controlled by passing a fluid through a plurality of separate channels through individual portions of the first plate and/or the second plate and the third plate.

As another example, a second embodiment of the high pressure heat exchanger 24 can comprise (i) a first plate, (ii) a second plate attached to the first plate and separated by a first spacer and a second spacer arranged between the first plate and the second plate, and (iii) a third plate attached to the second plate and separated by a third spacer and a fourth spacer arranged between the second plate and the third plate. The first plate, the second plate, the first spacer and the second spacer can define a first temperature-controlled passage for the meat emulsion to pass through the high pressure heat exchanger 24. The second plate, the third plate, the third spacer and the fourth spacer define a second temperature-controlled passage for the meat emulsion to pass through the high pressure heat exchanger 24.

Temperatures within the first and second temperature-controlled passages of the high pressure heat exchanger 24 can be controlled by passing a fluid through at least one channel in a portion of at least one of the first plate, the second plate or the third plate. For example, the first plate, the second plate and the third plate can define a plurality of individual temperature-controlled zones. The temperatures of individual temperature-controlled zones can be controlled by passing a fluid through a plurality of separate channels through individual portions of the first plate, the second plate and/or the third plate.

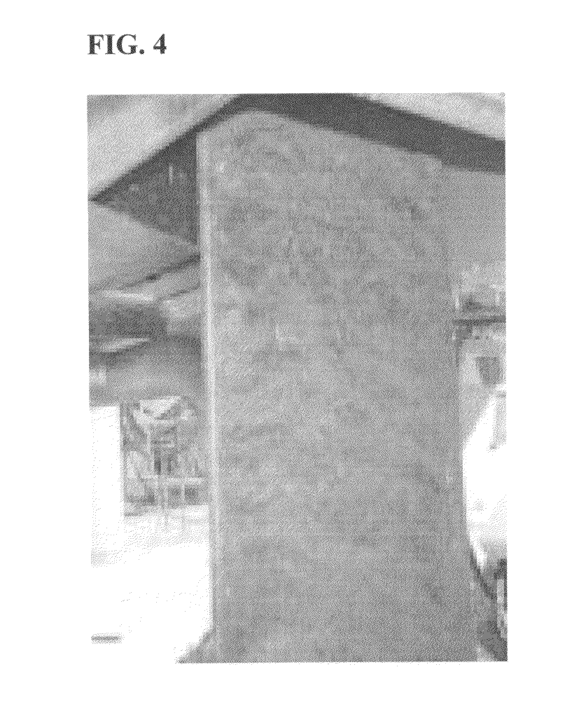

Regardless of the embodiment of the high pressure heat exchanger 24, the set meat emulsion is preferably discharged from the high pressure heat exchanger 24 as a long slab (FIG. 4) having a temperature of about 65° C. to 100° C. The set meat emulsion preferably has a moisture content not greater than about 30%, more preferably not greater than about 25%, most preferably about 17%, and a water activity of about 0.85 or less, preferably about 0.80 or less. In some embodiments, the water activity is about 0.75 or less, about 0.70 or less, or even about 0.65 or less.

Upon discharge from the high pressure heat exchanger 24, the set meat emulsion can be rapidly cooled by evaporative cooling to a temperature in the range of 60° C. to 93° C. In an embodiment, the system 10 comprises a cutting device 26, such as a rotary cut-off knife, a water jet knife, a knife grid or the like, that may be mounted at the discharge end of the high pressure heat exchanger 24 to cut the product into pieces of a desired size, e.g. from about 5 mm to about 50 mm. If desired, the product may be cut down the center to allow the product to more rapidly cool. The meat emulsion chunks thus formed have excellent integrity and strength and will retain their shape and fiber characteristics when subjected to commercial canning and retorting procedures such as those required in the production of canned foods having a high moisture content. The meat emulsion chunks disclosed herein preferably are a semi-moist pet food but can be a dry pet food in some embodiments.

The meat emulsion pieces can optionally be subjected to a number of post-discharge steps. For example, the meat emulsion pieces may be moved by a transport device 28 to a sieve 30 that may be used to obtain meat emulsion pieces of a desired size, for example by facilitating removal of fine particles generated by the operation of the cutting device 26 upon the set meat emulsion. In an embodiment, the transport device 28 is a pneumatic transport device, such as a device that uses a vacuum and/or pressure to transport the discharged meat emulsion pieces.

The meat emulsion pieces, unsieved or sieved, can optionally be conveyed to a coating device 32, for example a tumble coater, in which the meat emulsion pieces are coated with a fat, such as tallow, and/or another palatability enhancer, such as animal digest. An animal digest is material which results from chemical and/or enzymatic hydrolysis of clean, undecomposed animal tissue, excluding hair, horns, teeth, hooves, and feathers.

The meat emulsion pieces, uncoated or coated, can optionally be subjected to a cooling device 34. In an embodiment, the system 10 comprises a storage device 36, such as a horizontal storage device (e.g. a storeveyor), in which the meat emulsion pieces, coated or uncoated, can be stored.

The meat emulsion pieces can be packaged by themselves as a pet food or alternatively combined with another comestible product, such as a gravy, a broth or dry kibbles to create a blended pet food. The other comestible product may enable the blended pet food to have a desired nutritional profile; for example, the other comestible product can provide ingredients absent in the meat emulsion pieces and/or provide an additional amount of an ingredient present in the meat emulsion pieces to achieve an increased amount thereof in the blended pet food.

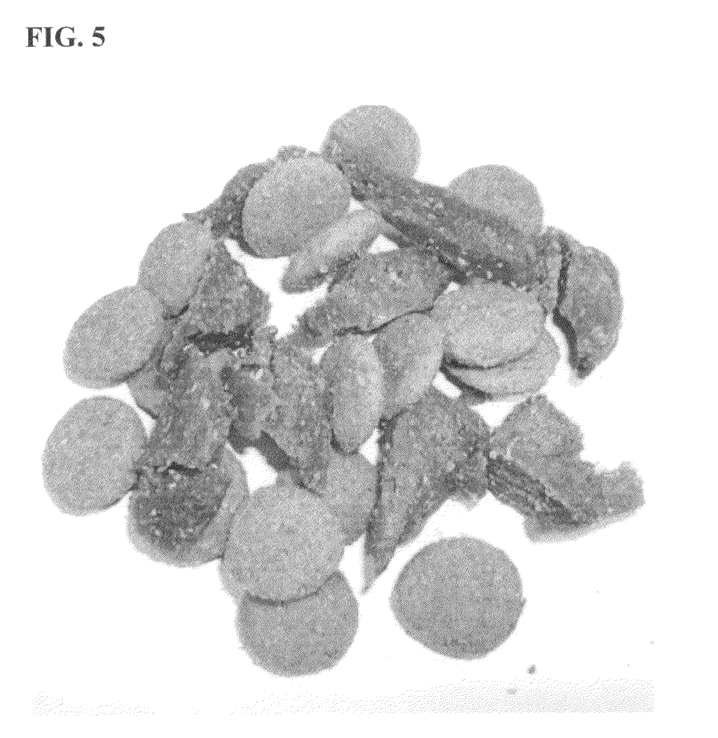

FIG. 5 shows an embodiment of a blended pet food that comprises kibbles and the meat emulsion pieces provided by the present disclosure. In an embodiment, the meat emulsion pieces are 5% to 25% of the blended pet food, for example about 15% of the blended pet food, and the kibbles are 75% to 95% of the blended pet food, for example about 85% of the blended pet food.

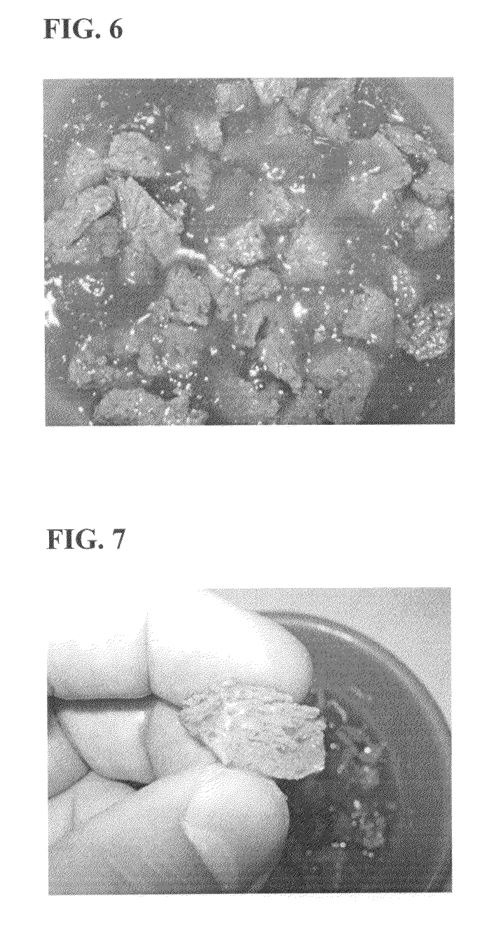

In an embodiment, the meat emulsion pieces are used for the production of a canned pet food product, for example a wet pet food. FIGS. 6 and 7 show an embodiment of a blended pet food that comprises gravy and the meat emulsion pieces provided by the present disclosure. For example, a suitable gravy may be prepared by heating a mixture of water, starch, and a condiment such as parsley, oregano, and the like. The meat emulsion pieces (preferably chunks) and the gravy can be filled into cans in the desired proportions, and then the cans can be vacuum-sealed and retorted under time-temperature conditions sufficient to effect commercial sterilization. Conventional retorting procedures may be used. Typically, a retorting temperature of about 118° C. to about 121° C. for approximately 40 to 90 minutes is satisfactory in producing a commercially sterile product.

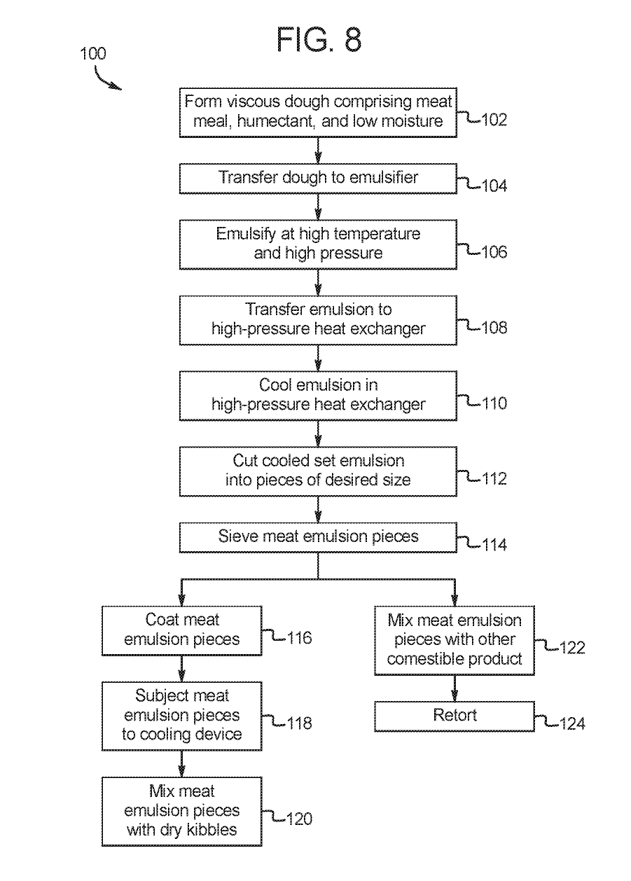

FIG. 8 is a flowchart of an embodiment of a method 100 for making a meat emulsion product according to the present disclosure. In Step 102, a dry mix comprising one or more meat meals and a liquid mix comprising a one or more humectants can be combined to form a high viscosity dough. Step 102 can be performed in a mixer, preferably a batch mixer.

Preferably the one or more meat meals are the only meat in the dough. In various embodiments, the one or more meat meals are at least 15%, preferably at least 30%, more preferably at least 35% of the dough, and even at least 45% of the dough in some embodiments. Preferably the dry mix comprises one or more dry proteinaceous materials. In an embodiment, the dry proteinaceous material is included in the meat emulsion in an amount from about 5% to about 20% of the dough. Non-limiting examples of suitable dry proteinaceous materials include wheat gluten, soy flour, soy protein concentrate, soy protein isolate, egg albumin, nonfat dry milk, and combinations thereof. Optionally the dry mix can include other components in addition to the one or more meat meals and the dry proteinaceous materials, such as one or more of a vitamin, a mineral, a preservative, an antioxidant, a colorant, cereal materials from (e.g., wheat, corn, rice, barley, oats, sorghum, millet, rye, or triticale), other grains such as buckwheat, amaranth, quinoa, wild rice, teff, spelt.

In preferred embodiments, the humectant is one or more of glycerol (glycerin), sorbitol, propylene glycol (e.g., monopropylene glycol), butylene glycol, polydextrose, or combinations thereof. The humectant is preferably glycerol and/or propylene glycol and is more preferably glycerol only. In various embodiments, the humectant is from about 4% to about 25% of the dough. The liquid mix also contains water, preferably in an amount not greater than about 32% of the dough, more preferably an amount not greater than about 30% of the dough. In some embodiments, the amount of the water is not greater than about 20% of the dough, for example an amount that is about 17% of the dough.

In Step 104, the dough formed by the dry and liquid mixes can be transferred by a pump. In Step 106, the dough can be subjected to a temperature above about 100° C., for example about 120° C. to about 165° C., preferably between about 145° C. to about 155° C., and subjected to a pressure of approximately about 40 psi to about 500 psi, preferably about 60 psi to 350 psi, to form a meat emulsion. Preferably, the meat emulsion is comminuted while subjected to these temperatures and pressures. These temperatures and pressures coagulate the protein in the meat emulsion to set the emulsion and form a firm emulsion product. In an embodiment, Step 106 is performed for a time period of not greater than about 60 seconds. Preferably Step 106 is performed in an extrusion mill. Preferably the dough has not been subjected to any emulsification prior to Step 106.

In Step 108, the hot meat emulsion can be transferred by a positive displacement pump, for example a gear or lobe pump, at high pressures of about 80 psi or higher. For example, the hot meat emulsion can be pumped at pressures of about 80 psi to about 600 psi, preferably about 100 psi to about 500 psi, and most preferably 140 psi to about 350 psi. The hot meat emulsion can also be pumped at pressures higher than 600 psi using suitable equipment.

In Step 110, the meat emulsion can be cooled, for example by a high pressure heat exchanger, preferably a high pressure plate heat exchanger. The meat emulsion can be retained in the high pressure heat exchanger at a pressure above the vapor pressure of the emulsion until the protein in the meat emulsion has coagulated sufficiently to set the emulsion and form a firm emulsion product which retains its shape and structure when discharged from the high pressure heat exchanger. In an embodiment, the meat emulsion is cooled while subjected to a pressure of at least 70 psi. In an embodiment, Step 110 is performed for a time period between a few seconds and about 3 minutes, preferably between about 1.0 and about 1.5 minutes.

Preferably, Step 110 forms a set meat emulsion that is a long slab having a temperature of about 65° C. to 100° C.; a moisture content not greater than about 30%, preferably not greater than about 25%; and a water activity of about 0.85 or less, preferably about 0.80 or less. In some embodiments, the water activity is about 0.75 or less, about 0.70 or less, or even about 0.65 or less.

In Step 112, the meat emulsion pieces may be cut into a desired size. In Step 114, the meat emulsion pieces may optionally be subjected to a sieve to further ensure that the desired size is achieved.

In an embodiment, the meat emulsion pieces are coated with a fat, such as tallow, and/or another palatability enhancer, such as animal digest (Step 116). In Step 118, the meat emulsion pieces, uncoated or coated, may optionally be subjected to cooling. In Step 120, the meat emulsion pieces may optionally be combined with another comestible product, such as dry kibbles to create a blended pet food, such as a dry or semi-moist pet food.

In another embodiment, the meat emulsion pieces are mixed with a gravy or jelly to form a wet pet food, such as a chunks-and-gravy product, a stew, or the like (Step 122). In Step 124, the resultant wet pet food may be retorted in a can.

In another aspect of the present disclosure, a method of providing nutrition to a pet is provided. The pet can be a companion animal. The method comprises administering any of the embodiments of the meat emulsion product disclosed herein. If the meat emulsion product is administered to a dog, preferably the humectant is propylene glycol and glycerin; if the meat emulsion product is administered to a cat, preferably the humectant is glycerol only.

### EXAMPLES

The following non-limiting examples are illustrative of embodiments of the present disclosure.

### Example 1

Table 1 shows the composition of an embodiment of an uncoated shelf-stable meat analog chunk according to the present disclosure.

TABLE 1

| | Composition |
|---|---|
| Ingredients | (%) |
| Dries - Fine Ground | |
| Meat By-product Meal (50% Protein) | 36.5 |
| Vital Wheat gluten | 20.0 |
| Sodium Chloride | 2.9 |
| Potassium Sorbate | 0.6 |
| Calcium Propionate | 0.3 |
| Choline Chloride | 0.5 |
| Vitamins Premix | 1.5 |
| Mineral Premix | 1.5 |
| BHT Powder | 0.02 |
| Liquids | |
| Poultry Fat | 4.0 |
| Mono Propylene Glycol | 6.0 |
| Glycerin (86%) | 14.0 |
| Water | 12.18 |
| | 100 |

### Example 2

Table 2 shows the composition of an embodiment of a coated shelf-stable meat analog chunk according to the present disclosure.

TABLE 2

| | Composition |
|---|---|
| Ingredients | (%) |
| Uncoated Meat Analog Chunks (Table 1) | 89.5 |
| Tallow | 7.5 |
| Liquid Chicken Digest | 3.0 |
| | 100 |

### Example 3

Table 3 shows properties of a blended coated meat analog and a commercial dry dog food kibble. These properties of the blended coated meat analog demonstrate shelf stability thereof.

TABLE 3

| | Coated Meat Analog | Commercial Dry |
|---|---|---|
| | Chunks | Dog Food Kibbles |
| Composition (%) | 25 | 75 |
| Moisture at Blending (%) | 17.0 | 6.3 |
| Water Activity at Blending | 0.64 | 0.55 |
| Moisture after 6 months (%) | 13.3 | 8.1 |
| Water Activity after 6 months | 0.595 | 0.595 |

### Example 4

Palatability tests were performed in which meat analog chunks according to the present disclosure were blended with commercial kibbles and then compared to those commercial kibbles and also another commercial kibbles. Table 4 shows the results.

TABLE 4
% Consumption A versus B

| A | B | |
|---|---|---|
| Blended 15% Meat Analog/ | | 100% |
| 85% Commercial Dry Dog | 100% Commercial Dry | Commercial Dry |
| Food 1 | Dog Food 1 | Dog Food 2 |
| 81.5 | 19.5 | — |
| 64 | — | 36 |

### Example 5

Palatability tests were performed in which meat analog chunks according to the present disclosure were blended with commercial kibbles and then compared to those commercial kibbles and also another commercial kibbles. Table 5 shows the results.

TABLE 5
% Consumption A versus B

| A | B | |
|---|---|---|
| Blended 15% Meat Analog/ | | 100% |
| 85% Commercial Dry Dog | 100% Commercial Dry | Commercial Dry |
| Food 3 | Dog Food 3 | Dog Food 4 |
| 70 | 30 | — |
| 80 | — | 20 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of producing a meat emulsion product comprising:
forming a dough comprising a humectant, at least 15% of a meat meal, and not greater than about 32% moisture content;
subjecting the dough to a temperature above about 100° C. and a pressure of about 40 to about 500 psi to form a meat emulsion; and
decreasing the temperature of the meat emulsion in a heat exchanger to set the meat emulsion, and the meat emulsion product comprises the set meat emulsion.

2. The method of claim 1, wherein the humectant comprises glycerol.

3. The method of claim 1, comprising comminuting the dough in an emulsion mill that subjects the dough to the temperature above about 100° C. and the pressure of about 40 psi to about 500 psi.

4. The method of claim 3, comprising conveying the meat emulsion from the emulsion mill to the heat exchanger with a positive displacement pump at a pressure of at least about 80 psi.

5. The method of claim 1, wherein the heat exchanger is a plate heat exchanger comprising plates configured for the meat emulsion to travel therebetween.

6. The method of claim 1, wherein the heat exchanger is configured to subject the heat-set meat emulsion to a pressure of at least 70 psi.

7. The method of claim 1, wherein the meat meal is the only meat in the dough.

8. The method of claim 1, wherein the forming of the dough comprises adding at least one proteinaceous material to the meat meal, and the dough comprises the at least one proteinaceous material in an amount not greater than about 20% of the dough.

9. The method of claim 8, wherein the at least one proteinaceous material comprises vital wheat gluten.

10. The method of claim 8, wherein a liquid mix comprises water and the humectant, a dry mix comprises the meat meal and the at least one proteinaceous material, and the forming of the dough comprises adding the dry mix to the liquid mix.

11. The method of claim 10, comprising heating the liquid mix to at least about 70° C. before adding the liquid mix to the dry mix.

12. A meat emulsion product comprising a plurality of fibrous structures, at least 15% of a meat meal, and a humectant.

13. The meat emulsion product of claim 12, having a water activity not greater than about 0.85.

14. The meat emulsion product of claim 12, comprising a proteinaceous material additional to the meat meal, and the proteinaceous material is not greater than about 20% of the meat emulsion product.

15. The meat emulsion product of claim 12, having a moisture content not greater than about 30%.

16. The meat emulsion product of claim 12, wherein the meat emulsion product is shelf-stable for at least one year.

17. The meat emulsion product of claim 12, wherein the meat meal is the only meat in the meat emulsion product.

18. A pet food comprising:
a meat emulsion product comprising a plurality of fibrous structures, at least 15% of a meat meal, and a humectant; and
at least one other comestible ingredient.

19. The pet food of claim 18 wherein the at least one other comestible ingredient comprises dry kibbles.

20. The pet food of claim 18 wherein the at least one other comestible ingredient comprises a gravy.
